(19) United States
(12) Patent Application Publication
(10) Pub. No.: US 2018/0000119 A1
(43) Pub. Date: Jan. 4, 2018

(54) ENHANCED MILK PRODUCTION EFFIENCIENCY IN DAIRY COWS

(71) Applicant: Dow AgroSciences LLC, Indianapolis, IN (US)

(72) Inventors: William P. WEISS, Indianapolis, IN (US); Karl NESTOR, Indianapolis, IN (US)

(21) Appl. No.: 15/540,377

(22) PCT Filed: Dec. 30, 2015
(86) PCT No.: PCT/US2015/068010

§ 371 Date: Jun. 28, 2017

Related U.S. Application Data
(60) Provisional application No. 62/098,232, filed on Dec. 30, 2014.

(51) Int. Cl. A23K 10/30; A23K 30/15; A23K 20/158; A23K 20/20; A23K 10/38; A23K 50/10

(52) U.S. Cl. CPC A23K 10/30; A23K 10/38; A23K 50/10; A23K 20/158; A23K 20/30; A23K 30/15

(57) ABSTRACT

A method of enhancing milk production efficiency in dairy cattle that comprises feeding the dairy cattle with a feed ration comprising a corn silage made from a brown midrib/floury-2 corn hybrid. Upon being fed to dairy cows, a feed ration comprising brown midrib/floury-2 corn silage provides at least about 4% higher in the amount of milk produced per unit of the feed intake, compared to a feed ration comprising non-brown midrib corn silage.

### CROSS-REFERENCE TO RELATED APPLICATIONS

This is a national phase entry under 35 U.S.C. §371 of international Patent Application PCT/US2015/068010, filed Dec. 30, 2015, published in English as International Patent Publication No. WO2016109633 on Jul. 7, 2016, which claims priority to U.S. Patent Application No. 62/098,232 filed on Dec. 30, 2014, all of which are incorporated in their entirety by reference herein.

### TECHNICAL FIELD

The present disclosure relates generally to feed compositions and methods for increasing milk production efficiency in dairy cows. Particular embodiments relate to methods for enhancing milk production efficiency in dairy cows by feeding silage made from corn plants exhibiting the brown midrib phenotype.

### BACKGROUND

Agriculturally important uses of corn (maize) include silage. Silage is fermented, high-moisture fodder that can be fed to ruminants. It is fermented and stored in a process called ensilage or silaging, and is usually made from corn or other grass crops, including sorghum or other cereals, using the entire green plant. Silage may be made, e.g., by placing cut green vegetation in a silo, by piling it in a large heap covered by plastic sheet, or by wrapping large bales in plastic film. The ensiled product retains a much larger proportion of its nutrients than if the crop had been dried and stored as hay or stover. Bulk silage is commonly fed to dairy cattle, while baled silage tends to be used for beef cattle, sheep, and horses. Corn silage is popular forage for ruminant animals because it is high in energy and digestibility and is easily adapted to mechanization from the stand-crop to time of feeding. Corn silage generally is slightly brown to dark green in color, and has a light, pleasant smell.

Increasing the efficiency of milk production in dairy cattle has been an ongoing challenge facing the dairy industry. Even though a dairy cow's diet may meet the National Research Council recommended nutrient requirements, such diet may still lack some nutrients at increased levels required for higher milk production. Good sources of dietary energy are critical for dairy cattle during high-milk production periods. Attempts have been made to increase the efficiency of feed utilization and milk production by using various formulations and feed supplements.

Feed supplements have been employed by dairy farmers to increase milk production. For example, the FDA approval recombinant bovine somatotropin hormone (“bST hormone”) is administered to cows to enhance their milk production during the lactation phase.

Feeding brown midrib (BMR) corn silage to lactating dairy cows has been shown to increase dry matter intake (DMI) and milk production. Grant et al. (1995) J Dairy Sci. 78:1970-80; Oba and Allen (2000) J. Dairy Sci. 83:1333-1. M. Oba & M. S. Allen, “Effects of Brown Midrib 3 Mutation in Corn Silage on Dry Matter Intake and Productivity in High Yielding Cows,” J Daily Sci. 85:135-42 (1999) studies the effect of feeding dairy cows with the forage composed of conventional corn silage compared to the forage composed of BMR corn silage, which contains higher level of neutral detergent fiber digestibility (NDFD), and concludes that greater NDFD is associated with an increased dry matter intake (DMI) and therefore an enhanced milk production.

U.S. Pat. No. 5,767,080 discloses an enhanced milk production in dairy cows by feeding a feed ration comprising BMR corn silage and also administering an effective amount of a biologically active bST hormone supplement. The enhanced milk production is reported as due to an increase in the amount of total ration consumed per day (DMI) when BMR corn silage is fed. BMR corn silage contains a lower lignin content compared to the conventional corn silage. Therefore, cows fed with BMR corm silage show a higher amount of DMI compared to cows fed with conventional corn silage. As cows fed with BMR corn silage consume more silage per day, they produce higher amount of milk per day compared to cows fed with conventional corn silage.

Despite continued improvement in the development of dairy cattle feed rations, the enhanced milk production is reported as a result of increased DMI amount. Therefore, it is desirable to have dairy cattle feed rations with increased milk production efficiency per one unit of intake amount, e.g., that the amount of milk produced per one unit of the feed intake during one day period is enhanced.

### SUMMARY OF THE DISCLOSURE

Corn silages from brown midrib/floury-2 corn hybrids are disclosed that, upon being fed to dairy cattle, provide an enhanced milk production efficiency, e.g., increased amount of milk produced per one unit of the feed intake during one day period. Further disclosed are the finishing rations comprising such bm/fl2 corn silages. Methods are also disclosed for enhancing milk production efficiency in dairy cattle. In embodiments, diets comprising bm/fl2 corn silage are more digestible than control diets (despite the fact that bm3/fl2 silage has a similar lignin content as bm silage), as is observable both in the neutral detergent fiber digestibility of the diets and milk production from cows fed these diets. More information regarding bm3/fl2 corn, as may be utilized in the silage of embodiments herein, may be found in U.S. patent application Ser. No. 13/549,256, published on Jan. 17, 2013, as U.S. Patent Publication No. US 2013/0019338 A1, the contents of which are incorporated herein by this reference in their entirety.

Some embodiments include the surprising finding that milk protein yield is increased from cows fed either BMR or bm/fl2 silage, when compared to conventional silage. Also a surprising result disclosed herein is that milk production and energy efficiency is increased from cows fed bm/fl2 silage, even when compared to cows fed a BMR diet. Embodiments herein also include the further surprising result that milk urea-N was reduced for cows fed either BMR or bm/fl2 kernel genetics compared to conventional silage.

The foregoing and other features will become more apparent from the following detailed description of several embodiments.

### DETAILED DESCRIPTION

### I. Abbreviations

BMRBrown midrib
BW Body weight
CP Crude protein
DIM Days in milk
DM Dry matter
DMI Dry matter intake
DM % Percent composition on dry matter basis
IVNDFD In vitro neutral detergent fiber disappearance
IVStarchD In vitro starch disappearance
OM Organic matter
MUN Milk Urea Nitrogen
NEL Net energy for lactation
NDF Neutral detergent fiber
NRC (2001) The nutrient requirements of dairy cattle, 7^{th} Edition
SD Standard deviation
SEM Standard error of the mean
TMRTotal Mixed Ration

### II. Terms

Corn plant: As used herein, the term “corn plant” refers to a plant of the species, Zea mays (maize).

BMR corn: As used herein, the term “BMR corn” refers to corn varieties that contain a brown midrib mutation. BMR corn varieties typically exhibit a reddish brown pigmentation of the leaf midrib. BMR corn is also typically characterized by lower lignin content and higher fiber digestibility.

Dry matter: As used herein, the term “dry matter” refers to any feedstuff, including forage.

Neutral detergent fiber: As used herein the term “neutral detergent fiber” or “NDF” refers to the insoluble residue remaining after boiling a feed sample in neutral detergent. The major components are lignin, cellulose and hemicellulose, but NDF also contains protein, bound nitrogen, minerals, and cuticle. NDF is a measure of slowly digested material across a wide range of feeds. NDF levels in forage increase as the plant matures. Average levels of NDF in grass silage may be approximately 55 percent DM (550 g/kg DM). The content of NDF in a total ration may be between 35-50% DM. Diets with less than 32% NDF may cause problems with acidosis. Diets that contain over 50% NDF may be restricted in their intake potential. In particular embodiments, the content of NDF in a total ration may be between 29-35% DM.

Digestibility: As used herein the term “digestibility” refers to percentage of whole silage (ensiled stover and grain) or feed-ration components that is digested by animals. Greater digestibility is associated with higher energy intake.

Neutral detergent fiber digestibility: As used herein the term “neutral detergent fiber digestibility” or “NDFD” refers to percentage of neutral detergent fiber that is digestible. NDFD is determined in vitro by incubating a ground feed sample in live rumen fluid and measuring its disappearance to simulate the amount and rate of digestion that would occur in the rumen.

Silage: As used herein, the term “silage” refers to a certain type of storage forage. Generally, silage is made from plants (e.g., corn plants) in a process called ensilage. During this process, plants or plant parts undergo anaerobic fermentation caused by indigenous microorganisms (e.g., one or more strains of lactic acid bacteria, for example, Lactobacillus spec.) converting sugars to acids and exhausting any oxygen present in the crop material, which depletion of oxygen preserves the forage in conjunction with bacteria-generated volatile fatty acids, such as acetate, propionate, lactate, and butyrate. Silage is widely used for feeding milk and meat producing animals, such as dairy cattle and beef cattle.

Fiber source: As used herein, the term “fiber source” refers to a material obtained from a plant or microbial source, which material contains edible fibers. Practical, but not limiting examples of fiber sources include, the hulls of agricultural seed products such as from soy beans, or from grains such as rice, wheat, corn, barley; the stalks from such grains (straw); vegetable/plant-based soap stocks; corn stover, which typically includes the stalks, husks and leaves from a harvested corn plant; processed component fractions of agricultural products that are enriched in fiber, for example corn gluten feed; leaf material from any plant source; and distillers dried grains with or without solubles dried thereon. Thus, in particular examples, a fiber source may include, for example, mixtures of the following: alfalfa, barley products (e.g., straw), beet pulp, soy hulls, switch grass, corn fiber, soy fiber, cocoa hulls, corn cobs, corn husks, corn stove, wheat straw, wheat chaff, rice straw, flax hulls, soy meal, corn meal, wheat germ, corn germ, shrubs, and grasses. For the purpose of clarity in the present disclosure, distillers dried grains (with or without solubles) and distillers grains (with or without solubles) contain fiber, but are not considered “fiber sources.” Distillers dried grains (with or without solubles) and distillers grains (with or without solubles) are considered “corn co-products,” as set forth below.

Corn co-product: As used herein the term “corn co-product” refers to products that remain following the wet milling or dry milling of corn. Non-limiting examples of corn co-products include corn gluten, distillers grains, distillers grains plus solubles, distiller dried grains, distillers dried grains with solubles, condensed distillers solubles, bran cake, modified distillers grains, modified distillers grain plus solubles.

Supplement: As used herein, the term “supplement” refers to any ingredient included in a feed mix to enhance the nutritional value of the feed mix. Commonly used supplements include protein (e.g., soybean meal or urea), minerals (e.g., bone meal), energy (e.g., animal fat), and vitamins.

Days in milk (DIM): As used herein the term “days in milk” refers to the number of days during lactation that a cow has been milking, beginning with the last date of calving to the current test date.

Total mixed ration (TMR): As used herein the term “total mixed ration” refers to the single feed mix that is composed of forages, grains, protein feeds, minerals, vitamins and feed additives and formulated to a specified nutrient concentration.

Dry matter intake: As used herein the term “dry matter intake” or “DMI” refers to the amount of feed (on a dry matter basis) that a dairy cattle consumes in one day period. DMI is calculated as feed offered minus feed refused (all on a dry matter basis).

Milk production: As used herein the term “milk production” refers to the amount of milk produced by lactating dairy cattle during one day period.

Milk production efficiency: As used herein the term “milk production efficiency” refers to the amount of milk produced per one unit of the feed intake during one day period.

### III. Use of Different Brown Midrib Corn Silages in a Dairy Cattle Feed Ration

A. Overview

Described herein is a general strategy for increasing the milk production efficiency obtainable from silage-fed dairy cattle, as well as the feed rations suitable for feeding dairy cattle. Particular examples exploit the unexpected finding that the feed ration of certain formulation and comprising certain BMR/floury-2 corn silage can effectively enhance milk production efficiency (i.e., increasing the amount of milk produced per one unit of the feed intake during one day period). For example, a feeding ration composed of BMR/floury-2 corn silage made from corn FBDAS1 hybrid (bm3/fl2) increases the milk production efficiency, compared to the feed ration composed of conventional corn silage made from corn Mycogen 2A499 hybrid, or BMR corn silage made from corn F2F488 hybrid.

B. Silages Made from BMR Corn Hybrids

Either before or after ensiling, the BMR corn hybrids (F2F488 hybrid and FBDAS1 hybrid) show higher neutral detergent fiber (NDF) contents and higher in vitro neutral detergent fiber digestibility at 30 hours (IVNDFD-30 h), compared to the conventional corn hybrid (Mycogen 2A499).

TABLE 1, infra, shows the NDF and IVNDFD-30 h values prior to ensiling of the BMR corn hybrids (F2F488 hybrid and FBDAS1 hybrid) compared to those of the conventional corn hybrid Mycogen 2A499. As expected, corn F2F488 hybrid (hereinafter “BMR hybrid”) and corn FBDAS1 hybrid (a bm3/fl2 hybrid; referred to hereinafter as “BMR-Plus hybrid”) each has a higher NDF content (38.8% and 43.9%, respectively) based on dry matter basis compared to the NDF content of 37.7% for the conventional corn hybrid (hereinafter “control hybrid”). The IVNDFD-30 h values of the BMR hybrid and BMR-Plus hybrid are 72.3% and 71.9%, respectively, which are substantially higher than the IVNDFD-30 h value of the control hybrid (59.9%).

TABLE 2, infra, shows the nutrition composition of the silages made from different corn hybrids. The corn silage made from control hybrid (hereinafter “control silage”) has a substantially higher starch content and lower NDF content than the corn silage made from the BMR hybrid (hereinafter “BMR silage”) or the corn silage made from the bm3/fl2 hybrid BMR-Plus (hereinafter “BMR-Plus silage”). Furthermore, the BMR silage and BMR-Plus silage each contains only half the amount of lignin content (1.05% for BMR silage and 0.94% for BMR-Plus silage) compared to the lignin content of 2% on dry matter basis in the control silage.

The IVNDFD-30 h value is higher for the BMR hybrid and BMR-Plus hybrid compared to the control hybrid in both the pre-ensiling samples (TABLE 1) and the post-ensiling samples (TABLE 2). The pre-ensiling samples of BMR hybrid and bm3/fl2 hybrid BMR-Plus provide similar IVNDFD. However, the post-ensiling BMR-Plus hybrid is about 3 percentage units higher in IVNDFD compared to that of the BMR hybrid.

The pre-ensiling bm3/fl2 hybrid BMR-plus has a substantially higher in vitro starch disappearance (IVStarchD) than the pre-ensiling BMR hybrid. The post-ensiling BMR-Plus hybrid and the post-ensiling BMR hybrid show similar IVstarchD, and both are substantially lower than that of the control hybrid.

The control hybrid (pre- and post-ensiling) has substantially more starch than the BMR hybrid and bm3/fl2 hybrid BMR-Plus. The NDF content is lower in the control silage but by only about 1.6 to 2.4 percentage units compared to a starch difference of about 7 percentage units.

C. Preparation of Feed Rations

The feed ration comprises from about 40% to about 60%, based on dry matter basis, of corn silage. In one particular embodiment, the feed ration comprises, based on dry matter basis, from about 40% to about 60% of corn silage, from about 5% to about 15% of alfalfa silage, from about 5% to about 15% of ground corn gain, and from about 10% to about 50% of other ingredients. Non-limiting examples of the other ingredients may be soybean meal, soyhulls, dried distillers gains with solubles, animal or vegetable fat, mineral salt, sodium bicarbonate, limestone, dynamite, dicalcium phosphate, and trace nutrient premix.

In one more particular embodiment, the feed ration may comprise, based on dry matter basis, about 46% corn silage, about 10% alfalfa silage, from about 7.5% to about 12% ground corn gain, and other ingredients accounted for the rest. By way of non-limiting example, the feed ration may compose of the ingredient components as show in TABLE 3, infra. The control diet is the feed ration comprising control silage. The BMR diet is the feed ration comprising BMR silage, and the BMR-Plus diet is the feed ration comprising BMR-Plus silage (silage prepared from this bm3/fl2 hybrid).

TABLE 4, infra, shows the nutrition composition of the three feed rations. Since the control silage has substantially higher concentrations of starch and lower concentrations of NDF than the BMR silage and the BMR-Plus silage, and since higher forage NDF diets are usually recommended when the BMR silage is fed, the feed rations are formulated with the same concentration of corn silage as shown in TABLE 3, while the concentrations of corn grains, soyhulls and soybean meal are adjusted to equalize total NDF and starch amounts across the three feed rations.

D. Effect of Different Feed Rations on Milk Production Efficiency

The dry intake matter (DMI), milk production, and milk production efficiency of dairy cows are affected by the types of corn silage used in the feed ration.

DMI is higher for the BMR diet and the diet containing silage prepared from bm3/fl2 hybrid corn (i.e., the BMR-Plus diet) compared to the control diet. For example, as shown in TABLE 5, infra, the DMI for BMR diet and BMR-Plus diet are about 26.1 kg/day and about 25.8 kg/day, respectively; whereas, the DMI for control diet is about 25.3 kg/day. This is as expected, since the BMR diet and BMR-Plus diet each contains higher levels of NDF than the control diet.

The milk production is also higher for cows fed with the BMR diet or BMR-Plus diet compared to cows fed with the control diet. As shown in TABLE 5, milk production is about 42.02 kg/day for cows fed with the BMR diet, about 43.86 kg/day for cows fed with the BMR-Plus diet, and about 41.49 kg/day for cows fed with the control diet.

The increase in milk production for the BMR diet and BMR-Plus diet associated with the increased DMI of the BMR diet and BMR-plus diet, compared to the control diet, suggests that the enhanced milk production is due to the higher feed intake.

Unexpectedly, when considering the milk production efficiency (i.e., the amount of milk produced per one unit of DMI), the feed ration composed of BMR corn silage may not show a superior milk production efficiency compared to the feed ration composed of conventional corn silage. As shown in TABLE 5, the BMR diet provides a higher milk production than the control diet (42.02 kg/day vs. 41.49 kg/day), but the BMR diet shows a lower milk production efficiency (1.61 kg milk produced/kg DMI) compared to the control diet (1.64 kg milk produced/kg DMI). On the other hand, the diet containing silage prepared from bm3/fl2 hybrid corn (i.e., the BMR-Plus diet) provides a higher milk production than the control diet (43.86 kg/day vs. 41.49 kg/day), as well as the higher milk production efficiency of 1.70 kg milk produced/kg DMI compared to the control diet of 1.64 kg milk produced/kg DMI. Thus, the BMR-Plus diet shows about 4% higher in milk production efficiency compared to the control diet, and about 6% higher compared to the BMR diet. Further, the energy produced per intake unit is highest in the BMR-Plus diet and lowest in the BMR diet.

Without wishing to be bound by any theory, it is believed that the unexpectedly enhanced milk production efficiency by cows fed with the BMR-Plus diet, which contains bm3/fl2 hybrid corn silage, may be due to the increased starch digestibility and/or altered site of digestion (shifting from intestine to rumen), as well as due to the altered rumen fermentation that increases propionate level and decreases acetate level. Higher starch digestibility should increase propionate production, which is energetically more efficient than acetate production. The bm3/fl2 genotype of the BMR-plus hybrid may confer increased starch digestibility in the rumen which would increase ruminal propionate and perhaps microbial protein synthesis. This would also increase glucose synthesis by the liver, resulting in increased milk production and enhanced milk production efficiency.

### EXAMPLES

Materials and Methods

Corn Hybrids and Analysis of Corn Plants and Kennels

A conventional corn hybrid (Mycogen 2A499 from Mycogen Seed, Indianapolis, Ind., USA), a brown midrib corn F2F488 hybrid (“BMR hybrid”), and a brown midrib corn FBDAS1 hybrid (“BMR Plus hybrid”) were planted on the same day in similar fields located near a dairy facility in Wooster, Ohio, USA. The planted fields for each corn hybrid were in close proximity but were not adjacent to each other or to other corn fields. All agronomic practices were identical for the three fields. After about four months, corn hybrids were harvested for silage by the same forage harvester using a conventional chopper without kernel processing.

During the day when silage was chopped, six corn plants from each corn hybrid were selected randomly. The corn ear was removed from each selected corn plant and frozen at a temperature of about −20° F. The kernels were removed by hand from the corn ear and stored frozen until analysis. The corn plants and kennels from each of the three corn hybrids were analyzed for dry matter (DM) content, neutral detergent fiber (NDF) content, in vitro NDF digestibility after 30 hours (“IVNDFD-30 h”), starch content, in vitro starch digestibility after 3 hours (“IVStarchD-3 h”), crude protein (CP) content, and density as shown in TABLE 1. The NDF content, IVNDFD-30 h value, starch content, and IVStarchD-3 h value were measured by Dairyland Labs Inc., Arcadia, Wis., USA.

TABLE 1
Analyses of corn plants and kernels from three different corn
hybrids prior to ensiling

| | Control | BMR | BMR-Plus |
|---|---|---|---|
| | hybrid | hybrid | hybrid |
| | (Mycogen | (bm3) | (bm3/fl2) |
| | 2A499) | F2F488 | FBDAS1 |
| Corn plants | | | |
| DM, % | 37.8 | 32.5 | 30.4 |
| NDF, % | 37.7 | 38.8 | 43.9 |
| IVNDFD-30 h, % of NDF | 59.9 | 72.3 | 71.9 |
| Starch, % | 37.8 | 32.5 | 30.4 |
| IVStarchD-3 h, % of starch | 37.5 | 24.7 | 45.1 |
| Corn kennels | | | |
| DM, % | 65.1 | 67.1 | 58.1 |
| Starch, % | 70.0 | 71.0 | 69.4 |
| IVStarchD-3 h, % of starch | 20.3 | 22.0 | 22.8 |
| CP, % | 8.55 | 9.47 | 9.59 |
| Density, g/100 kennels | 43.1 | 43.0 | 40.4 |

As shown in TABLE 1, the BMR corn hybrids, either BMR hybrid or BMR-Plus hybrid, had higher NDF contents and IVNDFD-30 h values, compared to the control corn hybrid.

Preparation and Analysis of Silage Samples

Chopped corn plants of each corn hybrid were placed into separate bag silos (9 ft diameter times approximately 150 ft long). The bags were sealed and left undisturbed for approximately seven months. Throughout the silo filling process, samples were taken and composited to represent approximately one-third sections of each silo.

The silages made from each of the three corn hybrids were analyzed for nutrition composition as shown in TABLE 2. The amounts of each macronutrient reported in TABLE 2 were the means of six composite samples (three period samples and three samples taken during the digestion trials). The mineral amounts were the means of three period composite samples. The NDF content and starch content in each silage sample were determined by the Ohio Agricultural Research and Development Center (OARDC).

TABLE 2
Nutrition composition of the silages made from
three different corn hybrids (DM basis)

| | Control | BMR | BMR-Plus |
|---|---|---|---|
| | Silage | Silage | Silage |
| | (Mycogen | (bm3) | (bm3/fl2) |
| Nutrient | 2A499) | F2F488 | FBDAS1 |
| DM, % | 36.5 | 34.6 | 32.4 |
| Crude protein (CP), % | 7.6 | 7.9 | 7.3 |
| NDF (OARDC), % | 38.6 | 40.2 | 41.0 |
| NDF for IVNDFD, % | 39.5 | 40.8 | 42.7 |
| IVNDFD-30 h, % of NDF | 52.4 | 63.5 | 66.5 |
| Starch (OARDC), % | 36.9 | 29.9 | 29.8 |
| Starch for IVStarchD, % | 34.1 | 31.9 | 30.4 |
| IVStarchD-3 h, % of starch | 80.5 | 66.8 | 66.9 |
| Lignin, % | 2.01 | 1.05 | 0.94 |
| Ash, % | 3.46 | 4.04 | 3.37 |
| Long chain fatty acids, % | 2.73 | 2.38 | 2.68 |
| NEL-3X, Mcal/kg | 1.63 | 1.64 | 1.67 |
| Calcium (Ca), % | 0.12 | 0.15 | 0.15 |
| Phosphorus (P), % | 0.25 | 0.24 | 0.19 |
| Potassium (K), % | 0.98 | 1.12 | 0.83 |
| Magnesium (Mg), % | 0.12 | 0.15 | 0.15 |

Particle size distribution (Penn State Particle Size Separator)

| | | | |
|---|---|---|---|
| Top, % | 5.4 | 2.2 | 4.4 |
| Middle, % | 71.0 | 79.7 | 77.5 |
| Pan, % | 23.6 | 18.1 | 18.0 |

As shown in TABLE 2, the silage made from conventional corn Mycogen 2A499 hybrid (“control silage”) had substantially higher concentrations of starch and lower concentrations of NDF than the silages made from corn F2F488 hybrids (“BMR silage”) or the silages made from bm3/fl2 corn FBDAS1 hybrid (“BMR-Plus silage). The lignin content in the BMR silage or the BMR-Plus silage was only about half the amount of the lignin content in the control silage.

Preparation and Analysis of Feed Rations

Three feed rations composed of corn silage, alfalfa silage, corn gain, and concentrate were formulated to be similar in nutrient composition, as shown in TABLES 3 and 4. The control diet was the feed ration containing the control silage, which was the silage made from the conventional Mycogen 2A499 hybrid. The BMR diet was the feed ration containing silage made from the brown midrib hybrid F2F488 (BMR silage). The BMR-Plus diet was the feed ration containing silage made from the brown midrib/floury-2 hybrid FBDAS1 (BMR-Plus silage).

TABLE 3 showed ingredient composition of the three feed rations. As shown in TABLE 3, each of the feed rations composed of about 45.90% corn silage, about 10.10% alfalfa silage, from about 7.45% to about 11.10% of corn gain, and concentrate accounted for the rest of dry matter basis.

TABLE 3
Ingredient composition of the three feed rations (by DM %)

| | | | BMR-Plus |
|---|---|---|---|
| | Control Diet | BMR Diet | Diet |
| Control silage | 45.90 | — | — |
| (Mycogen 2A499 hybrid) | | | |
| BWR silage(bm3 hybrid) | — | 45.90 | — |
| F2F488 | | | |
| BMR-Plus silage | — | — | 45.90 |
| (bm3/fl2 hybrid) | | | |
| FBDAS1 | | | |
| Alfalfa silage | 10.10 | 10.10 | 10.10 |
| Corn gain, ground | 7.45 | 10.66 | 11.10 |
| Soybean meal, 48% CP | 15.53 | 16.37 | 16.50 |
| Soyhulls | 12.72 | 8.67 | 8.10 |
| Dried distillers grains with solubles | 5.00 | 0.50 | 0.50 |
| Animal-vegetable fat | 0.44 | 0.44 | 0.44 |
| Trace mineral salt | 0.50 | 0.50 | 0.50 |
| Sodium bicarbonate | 0.35 | 0.35 | 0.35 |
| Limestone | 1.00 | 1.00 | 1.00 |
| Dynamate | 0.18 | 0.18 | 0.18 |
| Dicalcium phosphate | 0.29 | 0.29 | 0.29 |
| Trace nutrient premix | 0.54 | 0.54 | 0.54 |

TABLE 4 showed nutrient composition of the three feed rations. The nutrient composition for each feed ration was calculated from the mean assayed values of silages and concentrate mixes (six composite samples per each ingredient, except three composite samples for the mineral ingredients). The NDF for IVNDFD values were the mean of three total mixed ration (TMR) samples for each of the feed rations. Three TMR were made for each feed ration using dried ground composite period samples. The TMR samples were assayed in duplicate for NDF and IVNDFD by Dairyland Laboratories, Inc. The NEL values were calculated using NRC (2001) with assayed NDF, lignin, crude protein (CP), ash, and fatty acids and treatment mean (DMI).

TABLE 4
Nutrient composition of the three feed rations
(by DM % except where noted)

| | Control | | BMR-Plus |
|---|---|---|---|
| | Diet | BMR Diet | Diet |
| Crude protein (CP) | 16.8 | 17.1 | 17.1 |
| Neutral detergent fiber (NDF) | 35.1 | 34.3 | 33.5 |
| Forage NDF | 22.3 | 23.0 | 23.4 |
| Corn silage NDF | 17.7 | 18.4 | 18.8 |
| NDF for IVNDFD | 33.7 | 32.7 | 32.2 |
| IVNDFD-30 h, % of NDF | 61.3 | 65.3 | 65.8 |
| Starch | 23.4 | 23.4 | 22.7 |
| Corn silage starch | 16.9 | 13.7 | 13.7 |
| Ash | 6.6 | 6.8 | 6.5 |
| Long chain fatty acids | 3.5 | 3.6 | 3.6 |
| NEL, Mcal/kg | 1.56 | 1.56 | 1.57 |
| Calcium (Ca) | 0.88 | 0.9.7. | 0.89 |
| Phosphorus (P) | 0.37 | 0.39 | 0.36 |
| Potassium (K) | 1.2.6 | 1.30 | 1.18 |
| Magnesium (Mg) | 0.21 | 0.22 | 0.22 |

Since the control silage had substantially higher concentration of starch and lower concentrations of NDF than the BMR silage and the BMR-Plus silage, the three feed rations either did not have the same concentration of corn silage or the same concentration of corn silage-derived NDF and starch. Higher forage NDF diets are usually recommended when the BMR silage is fed; therefore, the three feed rations were formulated with the same concentration of corn silage while the concentrations of corn grains, soybean meal and soyhulls were adjusted to equalize total NDF and starch amounts across the three feed rations. The three feed rations (control Diet, BMR diet, and BMR-Plus diet) essentially contained the same amounts of CP, starch, fat, minerals and vitamins, but different amounts of forage NDF, corn silage NDF, and corn silage starch. Unexpectedly total NDF in the three feed rations also differed (range was 1.6% units) because the NDF concentration of soyhulls changed after the experiment started.

### Cows and Study Design

Lactation Study

Twenty-one Holstein cows averaging 105 days in milk (DIM) with standard deviation of about 24 were used for the study. At the start of the experiment, the cows were divided into two parity groups: Group 1 composed of six cows with first lactation, and Group 2 composed of fifteen cows with second and greater lactations. The cows within each parity group were assigned randomly to 1 of 7 replicated 3×3 Latin squares and to a treatment diet sequence within each square.

Cows were moved into tie stalls and fed a preliminary diet (33.3% of each treatment diet in TABLE 3) for seven days to acclimate to stalls. After the preliminary period, cows were abruptly switched to one of three treatment diets in TABLES 3 and 4 and fed their respective diet for 28 days. Then, cows were abruptly switched to the next diet for period 2 and repeated again for period 3. Cows were fed once daily for ad libitum consumption (feed refusal averaged 6% of the amount fed) and milked twice daily. The feed offered and refused were weighed daily. Cows were weighed on two consecutive days at the start of each period and on the last two days of period 3.

Digestibility Experiment

Six of the 21 cows used in the lactation study were also used in a digestibility experiment. Two squares of multiparious cows were chosen at random, and all cows in one square and two cows within the other square were used. On the Monday during the last week of each period, the six selected cows were moved to digestion stalls and kept there for 4 days. During that time, feed intakes as well as fecal, urinary, and milk outputs were measured each day (Weiss et al, 2009). Feed ration, feed refusal, feces, urine, and milk were sampled daily and composited to form a single sample of each for each cow. After the fourth day, cows were moved back to their regular tie stalls.

### Sampling and Analyses

Feed rations were sampled weekly and composited by period. Weekly silage samples were assayed for DM (100° C. overnight), and TMR were adjusted for changes in silage DM if necessary. Composited samples were ground (silage samples were lyophilized first) through a 1 mm-screen (Wiley Mill, Arthur A. Thomas, Philadelphia, Pa.). Ground samples were assayed for DM (100° C. oven for 24 hours), NDF (Ankom200 Fiber Analyzer, ANKOM Technology, Fairport, N.Y., USA) with sodium sulfite and amylase (Sigma A3306, Sigma Diagnostics, St. Louis, Mo., USA), crude protein (Kjeldahl N×6.25), ash (AOAC, 2000), starch (Weiss and Wyatt, 2000), and long chain fatty acids ((Weiss and Wyatt, 2003).

In addition, samples of corn plants, corn kernels, fermented silage, and TMR (made in the laboratory from dry ground ingredient samples) were sent to Dairy and Laboratories Inc., Arcadia, Wis., USA for the analyses of IVNDFD-30 h and IVStarchD-3.

The TMR samples were not assayed for starch digestibility because they were ground through a 1 mm-screen. The in vitro starch assays were conducted on samples that were dried at a temperature of 60° C. overnight and then ground through a 4 mm-screen.

While cows were in the tie stalls, feed refusal was sampled from each cow twice during each period and assayed for DM to calculate the dry matter intake (DMI).

Milk was sampled after midday of day 26 and assayed for milk fatty acids. Milk was also sampled from all cows, both before midday and after midday, each week (four composited samples per period). These milk samples were assayed for milk fat, protein, lactose (B2000 Infrared Analyzer, Bentley Instruments, Chaska, Minn., USA) and milk urea nitrogen (MUN) (Skalar SAN Plus segmented flow analyzer, Skalar Inc., Norcross, Ga., USA) by DHI Cooperative Inc., Columbus, Ohio, USA.

For digestibility measurements, feeds, refusals, and feces were processed and analyzed as described above. Urine and milk samples were analyzed for nitrogen to calculate the nitrogen balance.

Milk production data were averaged within cow for each period and analyzed using Proc MIXED (SAS Institute, 2011). The model included the random effect of square (6 df), cows within square (random, 14 df), period (random, 2 df), treatment (fixed, 2 df), and error (38 df). For digestibility measurements, the model included cow (random, 5 df), period (random, 2 df), treatment (fixed, 2 df) and error (8 df).

TABLE 5
Milk production responses by cows fed with different feed rations

| | Control | BMR | BMR-Plus | SEM | |
|---|---|---|---|---|---|
| | Diet | Diet | Diet | value | P-value |
| BM, kg | 662 | 664 | 665 | 15.0 | NS |
| BM Change, kg/day | 0.27 | 0.06 | 0.27 | 0.32 | NS |
| DMI, kg/day | 25.3 | 26.1 | 25.8 | 0.36 | 0.09 |
| Milk Production, kg/day | 41.49 | 42.02 | 43.86 | 0.054 | 0.01 |
| Milk Components | | | | | |
| Fat, % | 3.04 | 2.91 | 3.06 | 0.13 | 0.04 |
| Fat, kg/day | 1.28 | 1.24 | 1.35 | 0.089 | 0.02 |
| Protein, % | 2.92 | 2.92 | 2.91 | 0.042 | NS |
| Protein, kg/day | 1.23 | 1.24 | 1.29 | 0.051 | 0.14 |
| Lactose, % | 4.83 | 4.80 | 4.86 | 0.06 | 0.10 |
| Lactose, kg/day | 2.03 | 2.06 | 2.16 | 0.10 | 0.10 |
| Energy, Mcal/kg | 0.65 | 0.63 | 0.65 | 0.016 | 0.10 |
| Energy, Mcal/day | 26.8 | 26.7 | 28.3 | 1.43 | 0.04 |
| MUN, g/dL | 16.1 | 14.6 | 15.4 | 0.70 | 0.01 |
| Milk/DMI, kg/kg | 1.64 | 1.61 | 1.70 | 0.054 | 0.01 |
| Energy/DMI, Mcal/kg | 1.06 | 1.01 | 1.10 | 0.044 | 0.01 |

TABLE 5 showed the milk production response by cows fed with the three different feed rations (i.e., control diet, BMR diet, and BMR-Plus diet).

As shown in TABLE 5, DMI was higher when cows were fed with the BMR diet or BMR-Plus diet, compared to the control diet. Milk production was also affected by the types of feed rations. Cows fed with the BMR diet or BMR-plus diet provided higher milk production than cows fed with the control diet.

However, when considering the milk production efficiency (i.e., the amount of milk produced per one unit of DMI), the BMR-Plus (bm3/fl2) diet showed about 4% higher in milk production efficiency compared to the control diet, and about 6% higher compared to the BMR diet. Unexpectedly, the BMR diet provided lower milk production efficiency than the control diet, even though the BMR diet provided higher milk production than the control diet. Further, the energy produced per intake unit was highest in the BMR-Plus diet and lowest in the BMR diet.

Milk fat content was low for all three feed rations. Milk protein content was not affected by the types of feed rations. Similarly, Milk lactose content was not affected by the feed rations.

TABLE 6
Nutrient digestibility and nitrogen partitioning by cows
fed with three different feed rations

| | Control | BMR | BMR-Plus | SEM | P- |
|---|---|---|---|---|---|
| | Diet | Diet | Diet | value | value |
| DMI, kg/day | 24.9 | 26.2 | 25.4 | 1.32 | NS |
| Wet feces, kg/day | 52.9 | 54.3 | 54.7 | 4.1 | NS |
| Urine, kg/day | 24.9 | 25.6 | 22.1 | 2.7 | NS |
| Wet manure, kg/day | 77.9 | 79.9 | 76.8 | 5.9 | NS |
| CP intake, kg/day | 4.31 | 4.21 | 4.24 | 0.28 | NS |
| NDF intake, kg/day | 8.47 | 8.90 | 8.52 | 0.45 | NS |
| Starch Intake, kg/day | 5.96 | 6.30 | 5.98 | 0.46 | NS |
| Digestibility Coefficients, % | | | | | |
| Dry Matter | 67.1 | 65.8 | 66.0 | 1.05 | NS |
| Organic Matter | 68.1 | 66.8 | 67.4 | 0.91 | NS |
| NDF | 52.1 | 52.0 | 50.3 | 3.58 | NS |
| Fatty acid | 73.0 | 73.5 | 72.7 | 1.02 | NS |
| Crude protein | 66.0 | 64.8 | 64.1 | 1.61 | NS |
| Starch | 86.3 | 83.7 | 88.3 | 1.08 | 0.04 |
| Nitrogen Partitioning | | | | | |
| Nitrogen (N) intake, | 690 | 673 | 679 | 44.6 | NS |
| g/day | | | | | |
| Urine N, % of N intake | 36.3 | 30.4 | 33.1 | 3.04 | NS |
| Fecal N, % of N intake | 34.0 | 35.2 | 35.9 | 1.6 | NS |
| Milk N, % of N intake | 28.7 | 29.6 | 30.0 | 2.1 | 0.06 |
| Nitrogen balance, g/day | 7.0 | 32.1 | 11.3 | 21.7 | NS |

TABLE 6 showed nutrient digestibility and nitrogen partitioning of the three different feed rations (i.e., control diet, BMR diet, and BMR-Plus diet).

Nutrient digestibility was not affected by the types of feed rations. Starch digestibility was lower when cows were fed with the BMR diet compared to cows fed with the control diet or BMR-Plus diet. Comparison between the BMR diet and BMR-plus diet was straight forward because the amount of starch provided by corn grain was identical. The higher starch digestibility was observed with the BMR-plus diet because the starch in the bm3/fl2 corn silage was more digestible. Comparisons of the BMR diet and BMR-Plus diet to the control diet were more difficult to interpret. This was because about 72% of the starch in the control diet was from corn silage; whereas, about 58% of the starch in the BMR diet and BMR-Plus diet was from corn silage. If the starch from the corn grain was less digestible than the starch from the silage, this could explain the difference in starch digestibility of the BMR diet or BMR-Plus diet compared to that of the control diet.

Nitrogen metabolism was not affected greatly by the types of feed rations. However, cows fed with the BMR-Plus diet (bm3/fl2) had the highest proportion of nitrogen consumed partitioned to milk.

Although there were some small differences in some fatty acids among the three feed rations, these could have been caused by differences in fatty acid profile of the three feed rations. The trans-10 C18:1 isomer and trans-10, cis-12 conjugated linoleic acid (CLA) were of more interest because of their relationship to milk fat depression. As shown in TABLE 7, the concentrations of these fatty acids were high which agrees with the overall low milk fat percentage we observed.

TABLE 7
Selected fatty acids (% of total fatty acids) in the milk
from cows fed with three different feed rations

| | | | BMR- | | |
|---|---|---|---|---|---|
| | Control | BMR | Plus | SEM | P- |
| | Diet | Diet | Diet | value | value |
| Short chain fatty | 29.1 | 27.8 | 28.7 | 0.95 | 0.01 |
| acid | | | | | |
| C 16:0 Fatty acid | 28.1 | 27.4 | 28.5 | 0.65 | 0.04 |
| C 18:0 Fatty acid | 10.6 | 10.7 | 10.0 | 0.44 | NS |
| C 18:1 trans-10 | 1.49 | 2.06 | 1.73 | 0.29 | 0.01 |
| Fatty acid | | | | | |
| Trans-10, cis-12 | 0.034 | 0.040 | 0.035 | 0.0034 | 001 |
| CLA | | | | | |

While the present invention has been described herein with respect to certain preferred embodiments, those of ordinary skill in the art will recognize and appreciate that it is not so limited. Rather, many additions, deletions, and modifications to the preferred embodiments may be made without departing from the scope of the invention as hereinafter claimed. In addition, features from one embodiment may be combined with features of another embodiment while still being encompassed within the scope of the invention as contemplated by the inventors.

We claim:

1. A method of enhancing milk production efficiency in dairy cattle, the method comprising:
preparing a feed ration comprising a corn silage made from a brown midrib/floury-2 corn hybrid; and
feeding the dairy cattle with the feed ration to provide an increased amount of milk produced per one unit of the feed ration consumed by the dairy cattle.

2. The method of claim 1, wherein the amount of milk produced per one unit of the feed ration consumed is at least about 4% higher for the feed ration comprising the brown midrib/floury-2 corn hybrid compared to a feed ration comprising brown midrib corn hybrid without a floury-2 genotype.

3. The method of claim 1, wherein the brown midrib corn hybrid is a bm3/fl2 corn hybrid.

4. The method of claim 1, wherein the feed ration comprises the corn silage in an amount from about 40% to about 60% on dry matter basis.

5. The method of claim 1, wherein the feed ration comprises from about 40% to about 60% of the corn silage, from about 5% to about 15% of alfalfa silage, and from about 5% to about 15% of ground corn gain based on dry matter basis.

6. The method of claim 5, wherein the feed ration further comprises at least one ingredient selected from the group consisting of soybean meal, soyhulls, dried distillers gains with solubles, animal or vegetable fat, mineral salt, sodium bicarbonate, limestone, dynamite, dicalcium phosphate, trace nutrient premix, and combinations thereof.

7. The method of claim 1, wherein feeding the dairy cattle with the feed ration comprising a brown midrib/floury-2 corn silage provides a higher energy amount per one unit of the feed ration consumed by the dairy cattle, compared to feeding the dairy cattle with a feed ration comparing silage prepared from a brown midrib corn without a floury-2 genotype.

8. A feed ration comprising, on dry matter basis:
from about 40% to about 60% of bm/fl2 corn silage;
from about 5% to about 15% of alfalfa silage; and
from about 5% to about 15% of ground corn gain,
wherein upon being fed to a dairy cattle, the feed ration provides an increased amount of milk produced per one unit of the feed ration consumed by the dairy cattle.

9. The feed ration of claim 8, wherein the corn silage is made from a bm3/fl2 corn hybrid.

10. The feed ration of claim 9, wherein upon being fed to a dairy cattle provides a higher proportion of nitrogen consumed partitioned to milk than a feed ration comprising corn silage made from a brown midrib corn hybrid without a floury-2 genotype.

11. The feed ration of claim 9, wherein the feed ration has a high concentration of starch and lower concentration of neutral detergent fiber (NDF) than a feed ration comprising corn silage made from a brown midrib corn hybrid without a floury-2 genotype.

12. The feed ration of claim 9, wherein the corn silage is made from a FBDAS1 corn hybrid.

13. The feed ration of claim 12, wherein upon being fed to a dairy cattle provides at least about 4% higher in an amount of milk produced per one unit of the feed ration consumed by the dairy cattle, compared to a feed ration comprising corn silage made from a brown midrib corn hybrid without a floury-2 genotype.

14. The feed ration of claim 12, wherein upon being fed to a dairy cattle provides a higher energy per one unit of the feed ration consumed by the dairy cattle, compared to a feed ration comprising corn silage made from a brown midrib corn hybrid without a floury-2 genotype.

15. The feed ration of claim 12, wherein upon being fed to a dairy cattle provides a higher starch digestibility than a feed ration comprising corn silage made from non-brown midrib corn hybrid.

16. The feed ration of claim 8, further comprising at least one ingredient selected from the group consisting of soybean meal, soyhulls, dried distillers gains with solubles, animal or vegetable fat, mineral salt, sodium bicarbonate, limestone, dynamite, dicalcium phosphate, trace nutrient premix, and combinations thereof.

17. The feed ration of claim 8, comprising about 46% the corn silage, about 10% the alfalfa silage, and from about 7.5% to about 12% of the ground corn gain on dry matter basis.

18. Corn silage produced from a brown midrib/floury-2 corn FBDAS1 hybrid.

19. The corn silage of claim 18, wherein upon being formulated into a feed ration and consumed by a dairy cattle provides a higher amount of milk produced per one unit of the feed ration consumed by the dairy cattle, compared to a feed ration comparing a corn silage produced from a brown midrib corn hybrid without a floury-2 genotype.

20. The corn silage of claim 18, wherein upon being formulated into a feed ration and consumed by a dairy cattle provides a higher energy amount per one unit of the feed ration consumed by the dairy cattle, compared to a feed ration comparing a corn silage produced from a brown midrib corn hybrid without a floury-2 genotype.
